(19) United States
(12) Patent Application Publication
(10) Pub. No.: US 2010/0070511 A1
(43) Pub. Date: Mar. 18, 2010

(54) REDUCING USE OF RANDOMNESS IN CONSISTENT UNIFORM HASHING

(75) Inventors: Mark Steven Manasse, San Francisco, CA (US); Frank D. McSherry, San Francisco, CA (US); Kunal Talwar, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/211,814

(22) Filed: Sep. 17, 2008

(51) Int. Cl. G06F 7/20; G06F 7/58; G06F 17/30

(52) U.S. Cl. 707/749; 708/250; 707/E17.009

(57) ABSTRACT

Documents that are near-duplicates may be determined using techniques involving consistent uniform hashing. A biased bit may be placed in the leading position of a sequence of bits that may be generated and subsequently used in comparison techniques to determine near-duplicate documents. Unbiased bits may be used in subsequent positions of the sequence of bits, after the biased bit, for use in comparison techniques. Samples may be used collectively, as opposed to individually, in the generation of biased bits. Sequences of bits may thus be produced not on a single sample basis, but for multiple samples, thereby amortizing the cost of generating randomness for the samples. Less than one bit of randomness per sample may be used.

### BACKGROUND

Large collections of documents typically include many documents that are identical or nearly identical to one another. Determining whether two digitally-encoded documents are bit-for-bit identical is straightforward, using hashing techniques for example. Quickly identifying documents that are roughly or effectively identical, however, is a more challenging and, in many contexts, a more useful task.

The World Wide Web is an extremely large set of documents, and has grown exponentially since its birth. Web indices currently include approximately five billion to 120 billion web pages, a significant portion of which are duplicates and near-duplicates. Applications such as web crawlers and search engines benefit from the capacity to efficiently detect many near-duplicates.

### SUMMARY

Documents that are near-duplicates may be determined using techniques involving consistent uniform hashing. A biased bit may be placed in the leading position of a sequence of bits that may be generated and subsequently used in comparison techniques to determine near-duplicate documents. Unbiased bits may be used in subsequent positions of the sequence of bits, after the biased bit, for use in comparison techniques.

In an implementation, samples may be used collectively, as opposed to individually, in the generation of biased bits. Sequences of bits may thus be produced not on a single sample basis, but for multiple samples, thereby amortizing the cost of generating randomness for the samples.

In an implementation, less than one bit of randomness per sample per input word may be used.

This summary is provided to introduce a selection of concepts in a simplified form that are further described below in the detailed description. This summary is not intended to identify key or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of a distributed computer system;

FIG. 2 is a block diagram of an implementation of a search engine system;

FIG. 3 is an operational flow of an implementation of a method of generating randomness for use in determining near-duplicate documents;

FIG. 4 is an operational flow of another implementation of a method of generating randomness for use in determining near-duplicate documents; and

FIG. 5 shows an exemplary computing environment.

### DETAILED DESCRIPTION

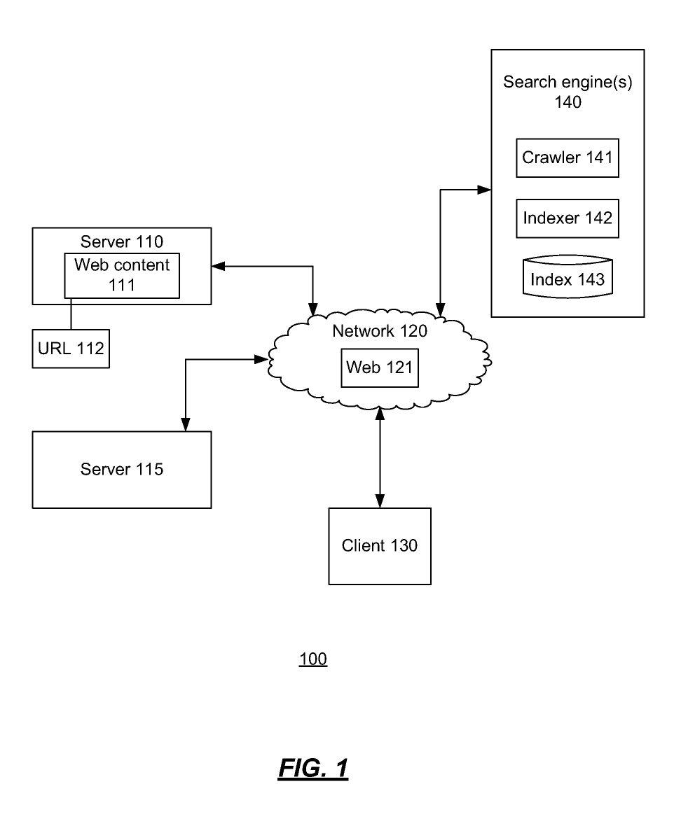

FIG. 1 shows an arrangement 100 of a distributed computing system which can generate and/or use randomness as described herein. A plurality of server computers (referred to as servers) 110, 115 are connected to each other by a communications network 120, for example, the Internet. The Internet includes an application level interface called the World Wide Web (web 121). The servers maintain web content 111, which may comprise, for example, multimedia content such as web pages. The location of web content 111 is specified by its uniform resource locator (URL) address 112. Although only two servers 110, 115 are shown, any number of servers may be connected to the network 120 and to each other.

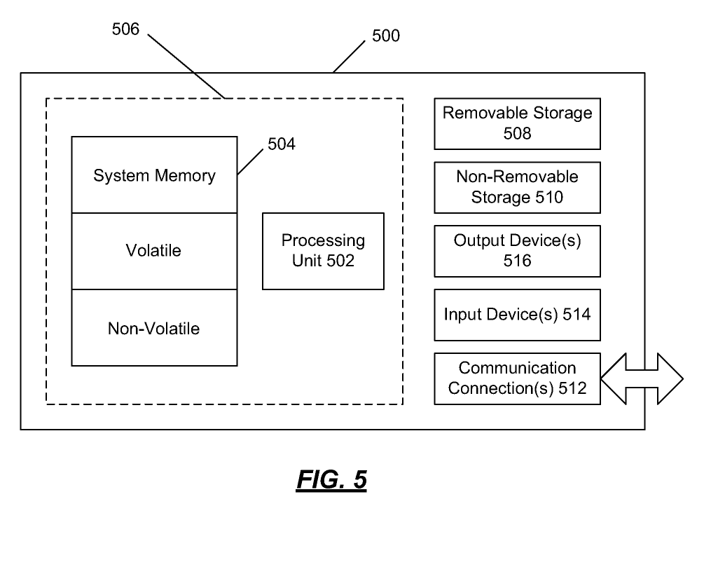

A client computer (referred to as a client) 130 may also be connected to the network 120. Although only one client 130 is shown, any number of clients may be connected to the network 120. An example client 130 is described in with respect to FIG. 5. Usually, the client 130 is equipped with a web browser. During operation of the arrangement 100, a user of the client 130 may monitor the web content 111 of the servers. The user may want to monitor specific content that has changed in a substantial way.

In order to assist the user of the client 130 to locate web content 111, one or more search engines 140 are also connected to the network 120. A search engine may use a crawler 141 to periodically scan the web 121 for changed or new content. An indexer 142 may maintain an index 143 of content located by the search engine. The search engine may also be equipped with a query interface to process queries submitted by users to quickly locate indexed content. A user of the client 130 may interact with the query interface via a web browser.

In systems like a large web index, a small sketch of each document may be maintained. For example, the content of complex documents expressed as many thousands of bytes can be reduced to a sketch of just hundreds of bytes. The sketch is constructed so that the resemblance of two documents can be approximated from the sketches of the documents with no need to refer to the original documents. Sketches can be computed fairly quickly, i.e., linear with respect to the size of the documents, and furthermore, given two sketches, the resemblance of the corresponding documents can be computed in linear time with respect to the size of the sketches.

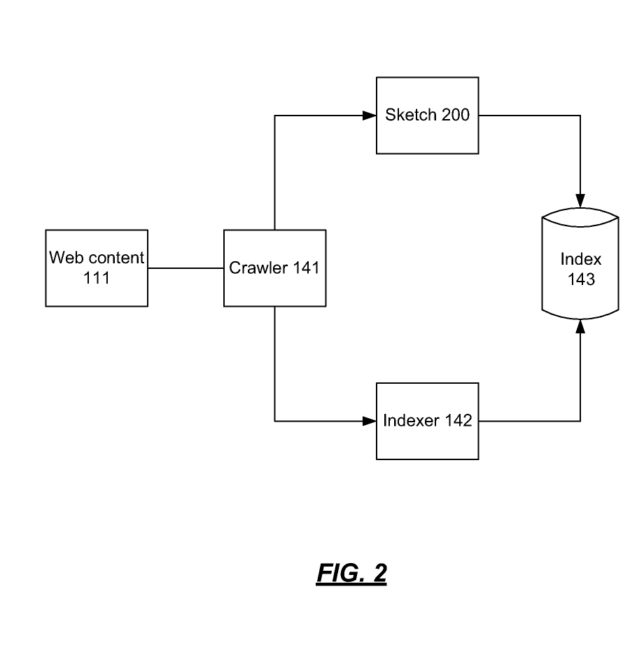

FIG. 2 is a block diagram of an implementation of a search engine system which can use randomness as described herein. The search engine may be used to provide a sketch 200 of each document of the web content 111 that is retrieved and indexed. The sketch 200 may be a bit or byte string which is highly dependent on the content of the document. The sketch 200 can be relatively short, for example, a couple of hundred bytes, and may be stored in the index 143 or other storage. As noted above, the sketches for documents can be determined in a time which is directly proportional to the size of the documents. By comparing resemblance estimates derived from sketches, it may be possible to determine whether documents are near-duplicates.

Documents are said to resemble each other (e.g., are near-duplicates) when they have the same content, except for minor differences such as formatting, corrections, capitalization, web-master signature, logos, etc. The sketches may be used to efficiently detect the degree of similarity between two documents, perhaps as measured by the relative intersection of the sketches. One way of doing this is to take samples from the document using a technique with the property that similar documents are likely to yield similar samples.

Many well known techniques may be used to determine whether documents are near-duplicates, and many of these techniques use randomness. Consistent uniform hashing is a technique for sampling an element from a set of elements which is uniformly random and consistent. The similarity between two sets of elements may be defined as the overlap between their item sets, as given by the Jaccard similarity coefficient. The Jaccard similarity coefficient is a statistic used for comparing the similarity and diversity of sample sets. The Jaccard similarity coefficient is defined as the size of the intersection divided by the size of the union of the sample sets. This is useful for determining near-duplicates of web pages and suppressing near-duplicates in search results, and may be used in recursive differential compression to suggest files with which to seed a compression engine.

Any known document comparison technique that can be used to measure the relative size of intersection of sketches may be used with the random values described herein. An exemplary version of a technique that uses consistent uniform hashing may compute a random value for each term in the document. The term corresponding to the numerically least value may be selected as a sample for that document.

There are several considerations involved in determining how to produce the random values that may be used with consistent uniform hashing techniques. High quality randomness is expensive, and as little of it as possible should be used per term in the document. Additionally, arbitrarily accurate random values should be able to be produced to avoid possible ties in large documents. The randomness also may depend only on the term in question, and not be shared across multiple terms. A technique is reproducible when another document containing the same term produces exactly the same value. Moreover, randomness is not efficiently produced one bit at a time, but rather in bulk, typically 128, but no less than 32, bits at a time. Many samples may be produced in parallel, and randomness may be shared across these samples, so long as the randomness depends only on the input.

A first known technique that may be used to determine the result to a query may compute 128 bits of randomness for each term and each parallel sample. The number of bits used is generally enough to avoid ties in any document that may be considered, and is an amount of randomness that is efficiently produced at a single time. However, the number of bits may be excessive, in that all 128 bits may generally not be needed to determine that a sample will not be worth pursuing as the smallest number (i.e., the result to the query).

Another known technique takes 128 bits of randomness and divides it into 16 groups of 8 bits. Each of 16 parallel samples (i.e., terms in a document) takes these values as their first 8 bits. In many cases, these 8 bits will be sufficient to establish that the sample (i.e., the term) will not be competitive for the title of “least value”, because it is already larger than the value of another candidate sample, in which case the sample being considered may be discarded. Otherwise, a further 128 bits may be produced to determine the precise value. This technique uses far fewer bits on average, as most of the parallel samples will not be feasible, and only 8 bits of randomness are used for each of those samples. Recently, techniques have been developed that use only 2 bits of randomness per sample on average.

As described further herein, less than one bit of randomness per sample, e.g., about one-third of a bit, may be used. This may provide a speed-up in the preprocessing phase of near-duplicate document determination, without any long-term impact to the quality of near-duplicate determination.

Biased coins are well known. In probability theory and statistics, a sequence of independent Bernoulli trials with probability ½ of success on each trial is called an unbiased coin. One for which the probability is not ½ is called a biased coin.

As described further herein, biased coins may be used to produce a set of unbiased results, and the production of large sets of biased coin values (also referred to as biased bits) may be emulated using unbiased coins. Such techniques are faster than those conventional techniques that use 2 or more bits of randomness per sample.

A biased bit may be placed in the leading position of a sequence of bits that may be generated and subsequently used in comparison techniques to determine near-duplicate documents. In an implementation, unbiased bits may be used in subsequent positions of the sequence of bits, after the biased bit, for use in comparison techniques. Alternatively or additionally, the bits in subsequent positions of the sequence of bits may be biased though not heavily biased (i.e., weakly biased). Unbiased bits may be used because they are easier to generate and they are better at rapidly breaking small sets of tied values.

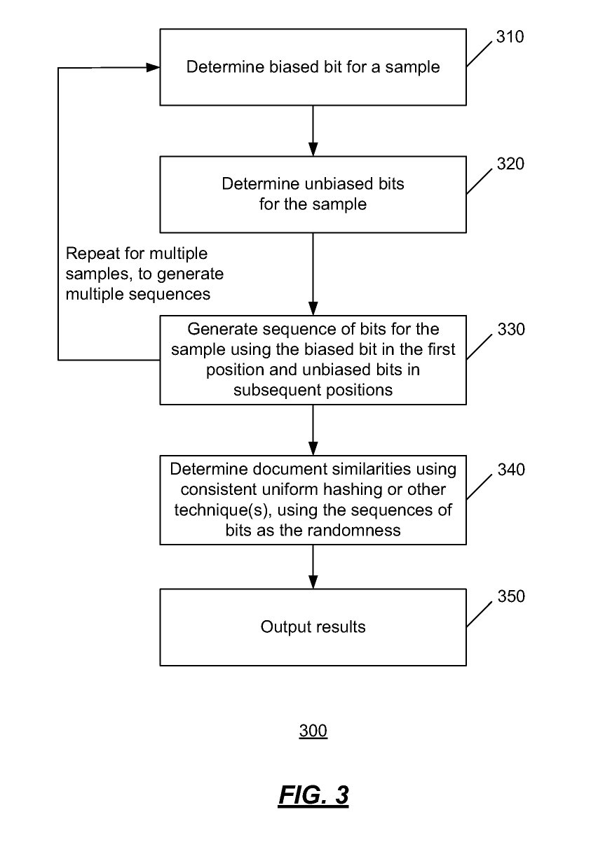

FIG. 3 is an operational flow of an implementation of a method 300 of generating randomness for use in determining near-duplicate documents. At stage 310, a biased bit may be determined for a sample. The biased bit may be determined using any technique, such as a technique involving a biased coin, for example.

At stage 320, unbiased bits for the sample may be determined using any technique. In an implementation, a random string of bits may be generated, and the sequence of bits up to a particular point or between particular points may be determined to be the unbiased bits. For example, a string of 128 bits may be generated and read until a bit of value 0 (i.e., a 0 bit) is encountered, and the sequence of bits up to this point may be provided as the determined unbiased bits.

At stage 330, a sequence of bits for the sample may be generated using the biased bit in the first position and the unbiased bits in the subsequent positions. Such a sequence of bits is the randomness that may be used in document comparison techniques. Multiple sequences of bits may be generated by repeating stages 310 through 330, one for each sample or word in a document, for example.

The sequences of bits that are determined may be used as the randomness in techniques that determine document similarities (e.g., near-duplicates) using randomness. In an implementation, at stage 340, document similarities may be determined using consistent uniform hashing or other techniques, using the sequences determined above as the randomness. The results may be outputted at stage 350.

Samples may be used collectively, as opposed to individually, in the generation of biased bits. Sequences of bits may thus be produced not on a single sample basis, but for multiple samples, thereby amortizing the cost of generating randomness for the samples.

A non-uniform distribution over random values for the generation of binary sequences may be used in a manner that puts bias on short and non-informative random values. Binary strings may be compared lexicographically, such that the first difference between the two binary strings is obtained, and the binary string with the lesser element is smaller. Such binary strings may be interpreted numerically by placing a decimal point at the front of the binary string and treating the two strings as the binary expansions of real values between 0.0 and 1.0. The two strings may be compared as one would normally compare such numbers. In other words, the numbers imagine a leading “decimal” point (though they are binary, not decimal), and so an output beginning with “1” is bigger than one beginning with “0010”, despite the former looking like “one” and the latter looking like “ten”.

In a technique that produces uniform binary sequences of bits, each of the binary values output may be 0 or 1 with equal probability. Such uniform binary values may be produced until a 1 is observed, resulting in the binary sequence. As noted above, the number of random bits used has been previously determined to be 2 for each of the samples. As described herein, fewer bits may be used by using non-uniform (i.e., biased) bits in the leading position only, and amortizing the cost of producing these leading non-uniform bits over k samples, using randomness in expectation that is less than k, the amount that may have been used if uniformly random bits were being used. It is noted that subsequent bits (e.g., those that follow a 0 in an implementation) may be determined using uniform randomness. However, there will be much fewer of these than in the uniform case, as the bias may be chosen to make 0 unlikely in an implementation.

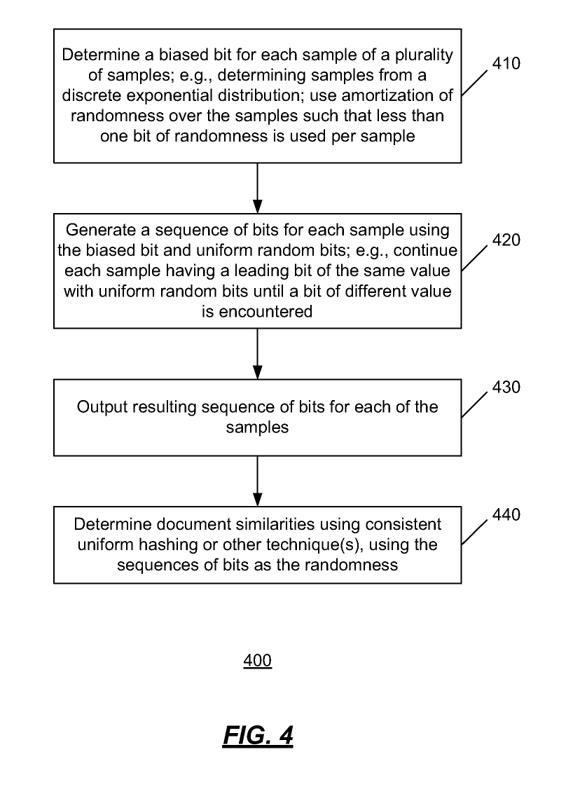

FIG. 4 is an operational flow of another implementation of a method 400 of generating randomness for use in determining near-duplicate documents. At stage 410, a biased bit for each sample of a plurality of samples may be determined. The randomness may be amortized over the samples, such that less than one bit of randomness is used per sample.

To produce the result of a set of k biased coin flips, each coin flip could be emulated independently, consuming 2 bits per coin, multiplied by the number of samples k. A more efficient approach is to produce the sequence of locations whose values (i.e., the results of the coin flips) come out 0, which will be relatively few. To do this, start with a first sample, and using uniform randomness, generate a draw from the distribution of the number of samples that are to be skipped to arrive at the next 0 bit. This distribution follows a discrete exponential distribution, where the probability that i samples are skipped is equal to (1−p)pⁱ, where p is the bias of each bit which is the probability that the bit has a value of 1 (i.e., a 1 bit).

Any technique may be used to draw from the discrete exponential distribution. For example, in an implementation, let a value space be binary numbers between 0.0 and 1.0. Suppose that for any particular value of i, more of the values start with 0.1 than start with 0.0, e.g. with probability p of starting with a 0.1, and with the bits that follow selected with equal probability. In such a case, most of the values will start with 0.1. The probability that the first j all start with 0.1 is pⁱ and the probability that the first j start with 0.1 and the next one starts 0.0 is (1−p)p^{j}. These sum to 1. Using a small expected string of uniform random bits, a value 0≦i<k may be determined such that a uniform random value between 0 and 1 falls between (1−p)pⁱ⁺¹ and (1−p)pⁱ, or a value smaller than (1−p)p^{k}. This uses only a few expected bits; if p≅(k−1)/k, the smallest of these is approximately 1/ke, so roughly 1+In k bits may suffice to determine where a random number falls. For parameters in this range, the expected number of values beginning 0.0 is one, so repeating this to find the next such value may not happen often.

At stage 420, a sequence of bits may be generated for each sample using the biased bit from stage 410 and uniform random bits. More particularly, in an implementation, having determined the samples that have a leading 0 bit, these samples may be continued using uniform random bits until a 1 is arrived at. For example, the sequence of bits up to a particular point such as a bit of value 1 may be determined to be the unbiased bits of the bit sequence of the sample. Processing may continue for each sample, such that the sequence of bits up to the point of encountering a 1 bit from the last point that a 1 bit was encountered is output as the biased bits for that sample.

The resulting sequence of bits for each of the samples may be outputted at stage 430. At stage 440, these sequences may be used in techniques for determining near-duplicates.

In an implementation, once a document has been processed, for each index i less than k, the set of candidate values may be collected and a set of candidate elements (for the determination of the element with the smallest value) may be established. For each of the candidate elements, a new binary sequence of bits may be produced (at this point no amortization of randomness may be used). This binary sequence of bits may be appended to the tail of each of the candidate elements and they may be compared again. If there are still ties, the process may be repeated until a single element differentiates itself.

The size of tied sets of elements should be small because the probability of having a large group of sequences of bits with an equal number of zeros at the front is small. This is true, except in the case that not a single element was selected for a zero, for some sample. This results in a trade-off for the value p, where the longer the documents are, the more feasible it is to make p small, as it is likely to obtain an element that avoids this case. At the same time, the number of parallel samples that are used makes it more likely that such a case will arise. The expected number of random bits used is at most:

E[bits]<=d(2+(1−p)k(2 log(k)+2))+128*k*(1+(d−1)p^{d})

where the number 128 represents a number of random bits that can be efficiently produced at a time, d is the number of words in a document, p is a target bias, and k is the number of parallel samples. It is noted that d may be measured, and k and p may be selectable.

By choosing p so that p itself is nearly one, but p^{d} is very close to zero, fewer random bits may be efficiently used. For example, the average web page may contain about 1000 words, and k may be taken to be about 100 by modern search engines. Thus using these values, E[bits]<=1000(2+(1−p)100(16))+12800(1+999p¹⁰⁰⁰)=1614800−p(1600000)+12800000p¹⁰⁰⁰.

Taking p=0.99, a non-optimal but straightforward to compute value, E[bits]<=30800+577.46. When the average number of bits per element sample is considered in such a case, it is roughly 0.31, which is substantially less than the 2 bits per sample used by prior work.

It is noted that the ordering may be more easily implemented by using native comparison instructions, but any ordering may be used that is mathematically equivalent. In particular, reverse-ordering, which exchanges 1 with 0 as used herein, may also be implemented using native operations on computers, and produces different, but equally significant, samples. Even more arbitrary changes to the ordering function (such as treating 0 as less than 1 at odd bit positions, and treating 0 as greater than 1 at even positions, for example) produces valid results.

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of generating randomness for use in determining near-duplicate documents, comprising:
determining a biased bit for a sample;
determining a plurality of unbiased bits for the sample;
generating a sequence of bits for the sample comprising the biased bit in a first position of the sequence and the unbiased bits in a plurality of subsequent positions of the sequence; and
providing the sequence of bits as randomness to a technique for determining near-duplicate documents.

2. The method of claim 1, wherein determining the unbiased bits comprises:
generating a random string of bits; and
selecting bits from the random string of bits as the unbiased bits.

3. The method of claim 1, wherein the technique for determining near-duplicate documents comprises a consistent uniform hashing technique.

4. The method of claim 1, further comprising:
generating a plurality of additional sequences of bits for a plurality of additional samples, each additional sequence comprising an associated biased bit in a first position of the additional sequence following by a plurality of associated unbiased bits; and
providing the additional sequences of bits as additional randomness to the technique for determining near-duplicate documents.

5. The method of claim 4, wherein generating the sequence of bits for the sample and generating the additional sequences of bits for the additional samples comprises determining positions of the bits for the sequences of bits using a discrete exponential distribution.

6. The method of claim 5, wherein the sequence of bits for the sample and each of the additional sequences of bits for the additional samples comprise a leading bit of the same value.

7. The method of claim 6, wherein the sequence of bits for the sample and each of the additional sequences of bits for the additional samples further comprise a plurality of uniform random bits.

8. The method of claim 4, further comprising amortizing randomness over the sample and the additional samples by producing the sequence of bits for the sample and the additional sequences of bits for the additional samples collectively.

9. The method of claim 1, wherein generating the sequence of bits for the sample uses less than one bit of randomness.

10. A method of generating randomness for use in determining near-duplicate documents, comprising:
determining a plurality of samples using a discrete exponential distribution;
generating a sequence of bits for each of the samples; and
providing the sequences of bits as randomness to a technique for determining near-duplicate documents.

11. The method of claim 10, wherein the sequence of bits for each of the samples comprises a leading bit the same value.

12. The method of claim 11, wherein generating the sequence of bits for each of the samples comprises continuing each of the sequences of bits with a plurality of uniform random bits.

13. The method of claim 10, wherein the technique for determining near-duplicate documents comprises a consistent uniform hashing technique.

14. The method of claim 10, wherein generating each sequence of bits for the samples uses less than one bit of randomness.

15. The method of claim 14, further comprising amortizing an amount of randomness over the samples such that each sequence of bits uses less than the one bit of randomness.

16. A computer-readable medium comprising computer-readable instructions for generating randomness, said computer-readable instructions comprising instructions that:
determine a biased bit and a plurality of unbiased bits for a sample;
generate a sequence of bits for the sample comprising the biased bit in a first position of the sequence and the unbiased bits in a plurality of subsequent positions of the sequence; and
output the sequence of bits as randomness.

17. The computer-readable medium of claim 16, further comprising instructions that determine near-duplicate documents using the randomness.

18. The computer-readable medium of claim 16, wherein the instructions that generate the sequence of bits for the sample comprise instructions that determine the bits for the sequence of bits using a discrete exponential distribution.

19. The computer-readable medium of claim 16, wherein generating the sequence of bits for the sample uses less than one bit of randomness.

20. The computer-readable medium of claim 16, further comprising instructions that amortize randomness over the sample and a plurality of additional samples by producing the sequence of bits for the sample and a plurality of additional sequences of bits for the additional samples collectively.
